(19) United States
(12) Patent Application Publication
(10) Pub. No.: US 2020/0041649 A1
(43) Pub. Date: Feb. 6, 2020

(54) SYSTEM AND METHOD FOR POINT CLOUD DIAGNOSTIC TESTING OF OBJECT FORM AND POSE

(71) Applicant: CMTE DEVELOPMENT LIMITED, Pinjarra Hills, Queensland (AU)

(72) Inventors: Matthew Edward Green, Fairfield, Queensland (AU); Tyson Govan Phillips, The University Of Queensland, Queensland (AU); Peter Ross McAree, St. Lucia, Queensland (AU)

(21) Appl. No.: 16/340,046

(22) PCT Filed: Oct. 7, 2016
(86) PCT No.: PCT/AU2016/050948

§ 371 Date: Apr. 5, 2019

(51) Int. Cl. G01S 17/89; G01S 17/42; G01S 7/48; G01S 17/02; G01S 7/481

(52) U.S. Cl. CPC G01S 17/89; G01S 17/42; G06T 2207/10028; G01S 17/023; G01S 7/4817; G01S 7/4808

(57) ABSTRACT

A method of determining the location of a candidate object in an environment, the method including the steps of: (a) capturing a 3D point cloud scan of the object and its surrounds; (b) forming a surface geometry model of the candidate object. (c) forming a range hypothesis test comparing an expected range from the geometry model of the candidate object in comparison with the measured range of points in the Lidar point cloud scan and deriving an error measure there between; (d) testing the range hypothesis for a series of expected locations for the surface geometry model of the candidate object and determining a likely lowest error measure.

### FIELD OF THE INVENTION

The present invention provides for systems and methods for the automated testing of objects form and pose.

### REFERENCES

Armbruster, W. and Hammer, M. (2012). Maritime target identification in fiash-ladar imagery. In SPIE Defense, Security, and Sensing, volume 8391. International Society for Optics and Photonics.
Bayes, T. and Price, R. (1763). An essay towards solving a problem in the doctrine of chances. Philosophical Transactions (1683-1775), pages 370-418.
Besl, P. J. and McKay, N. D. (1992). Method for registration of 3-d shapes. In Robotics-DL tentative, pages 586-606. International Society for Optics and Photonics.
Brosed, F. J., Aguilar, J. J., Guillomiá, D., and Santolaria, J. (2010). 3d geometrical inspection of complex geometry parts using a novel laser triangulation sensor and a robot. Sensors, 11(1):90-110.
Cabo, C., Ordoñez, C., García-Cortés, S., and Martínez, J. (2014). An algorithm for automatic detection of pole-like street furniture objects from mobile laser scanner point clouds. ISPRS Journal of Photogrammetry and Remote Sensing, 87:47-56.
Cavada, J. and Fadón, F. (2012). Application of laser technology for measurement and verification of marine propellers. In ASME 2012 11th Biennial Conference on Engineering Systems Design and Analysis, pages 467-475. American Society of Mechanical Engineers.
Choe, Y., Ahn, S., and Chung, M. J. (2014). Online urban object recognition in point clouds using consecutive point information for urban robotic missions. Robotics and Autonomous Systems. Cohen, J. (1995). The earth is round (p<. 05).
de Figueiredo, R. P., Moreno, P., Bernardino, A., and Santos-Victor, J. (2013). Multi-object detection and pose estimation in 3d point clouds: A fast grid-based bayesian filter. In 2013 IEEE International Conference on Robotics and Automation (ICRA), pages 4250-4255. IEEE.
Falk, R. and Greenbaum, C. W. (1995). Significance tests die hard the amazing persistence of a probabilistic misconception. Theory & Psychology, 5(1):75-98.
Gao, J. and Yang, R. (2013). Online building segmentation from ground-based lidar data in urban scenes. In 2013 IEEE International Conference on 3DTV, pages 49-55. IEEE.
Green, M. E., Ridley, A. N., and McAree, P. R. (2013). Pose verification for autonomous equipment interaction in surface mining. In 2013 IEEE/ASME International Conference on Advanced Intelligent Mechatronics (AIM), pages 1199-1204. IEEE.
Günther, M., Wiemann, T., Albrecht, S., and Hertzberg, J. (2011). Model-based object recognition from 3d laser data. In KI 2011: Advances in Artificial Intelligence, pages 99-110. Springer.
Huang, C.-H., Boyer, E., and Ilic, S. (2013). Robust human body shape and pose tracking. In 2013 IEEE International Conference on 3DTV, pages 287-294. IEEE.
IEC (2011). Functional safety of electrical/electronic/programmable electronic safety-related systems—general requirements. International electrotechnical commission, (IEC 61508).
Johnston, K. (2002). Automotive applications of 3d laser scanning Technical report, 34935 SE Douglas Street, Suite 110, Snoqualmie, Wash. 98065, howpublished=http://www.metronicsys.com/automotive-s.pdf, institution=Metron Systems Incorporated.
Kashani, A., Owen, W., Lawrence, P., and Hall, R. (2007). Real-time robot joint variable extraction from a laser scanner. In 2007 IEEE International Conference on Automation and Logistics, pages 2994-2999. IEEE.
Kashani, A., Owen, W. S., Himmelman, N., Lawrence, P. D., and Hall, R. A. (2010). Laser scanner-based end-effector tracking and joint variable extraction for heavy machinery. The International Journal of Robotics Research.
Kim, A. M., Olsen, R. C., and Kruse, F. A. (2013). Methods for lidar point cloud classification using local neighborhood statistics. In SPIE Defense, Security, and Sensing, pages 873103-873103. International Society for Optics and Photonics.
Lehment, N., Kaiser, M., and Rigoll, G. (2013). Using segmented 3d point clouds for accurate likelihood approximation in human pose tracking. International journal of computer vision, 101 (3): 482-497.
Liu, Z.-J., Li, Q., and Wang, Q. (2014). Pose recognition of articulated target based on ladar range image with elastic shape analysis. Optics & Laser Technology, 62:115-123.
Phillips, T., Green, M., and McAree, P. (2014). An adaptive structure filter for sensor registration from unstructured terrain. Journal of Field Robotics.
Rocha, L. F., Ferreira, M., Santos, V., and Paulo Moreira, A. (2014). Object recognition and pose estimation for industrial applications: A cascade system. Robotics and Computer-Integrated Manufacturing, 30(6):605-621.
Ross, S. M. (2010). Introductory statistics, chapter 9.3 Tests concerning the mean of a normal population: case of known variance, pages 394-400. Academic Press.
Silverman, B. W. (1986). Density estimation for statistics and data analysis, volume 26. CRC press.
Skotheim, O., Lind, M., Ystgaard, P., and Fjerdingen, S. A. (2012). A flexible 3d object localization system for industrial part handling. In 2012 IEEE/RSJ International Conference on Intelligent Robots and Systems (IROS), pages 3326-3333. IEEE.
Sturrock, P. (1994). Applied scientific inference. Journal of Scientific Exploration, 8(4):491-508.
Su, J., Srivastava, A., and Huffer, F. (2013). Detection, classification and estimation of individual shapes in 2d and 3d point clouds. Computational Statistics & Data Analysis, 58:227-241.
Teichman, A., Levinson, J., and Thrun, S. (2011). Towards 3d object recognition via classification of arbitrary object tracks. In 2011 IEEE International Conference on Robotics and Automation (ICRA), pages 4034-4041. IEEE.
Ugolotti, R. and Cagnoni, S. (2013). Differential evolution based human body pose estimation from point clouds. In Proceeding of the fifteenth annual conference on Genetic and evolutionary computation conference, pages 1389-1396. ACM.
Velodyne LiDAR Inc (2008). HDL-64E S2 and S2.1: High definition LiDAR sensor. 345 Digital Drive, Morgan Hill, Calif. 95037. Wohler, C. (2013). Three-dimensional pose estimation and segmentation methods. In 3D Computer Vision, pages 89-137. Springer.

### BACKGROUND OF THE INVENTION

Any discussion of the background art throughout the specification should in no way be considered as an admission that such art is widely known or forms part of common general knowledge in the field.

Whilst the automated identification of objects and their pose is well studied from many contexts, there has been little prior work on verifying knowledge of the pose and geometric form of objects from point cloud data.

The literature dealing with shape detection, pose estimation, and geometry identification problems is substantial (see, for example, Withler (2013)). ‘What is it?’ and ‘where is it?’ questions, arise often in manufacturing contexts where manipulation of components often requires knowledge of ‘where’ an object is and process decisions depend on ‘what’ an object is. Rocha et al. (2014), for example, presents an autonomous conveyor coating line that requires the ability to localize and identify objects of varying geometry. Three dimensional point-cloud models are used to train a support vector machine in the identification of eight different geometries that arrive randomly on the conveyor. Skotheim et al. (2012) uses CAD models of objects to aid in the localization that is required for pick and place operations of a handling robot. A recognition algorithm is employed to match oriented point pairs described by surface normals of the possible geometry models. These controlled environments allow for measurement sets to be segmented using a cluster routine prior to estimation.

Quality control is a domain in which ‘Is it what I think it is?’ verification problems arise. Cavada and Fadón (2012), for instance, use laser range finders to verify that marine propellers are manufactured within high-precision tolerances. Model mismatch is determined by the error in expected and actual range measurements taken on the geometry. Others have also employed model mismatch techniques to verify the as-manufactured geometry of complex engine parts in the automotive industry, see for example Brosed et al. (2010) and Johnston (2002).

The coupled nature of ‘where’ and ‘what’ has led others to estimate the pose and form of an object simultaneously. This strategy seems particularly suitable to determining the pose of humans. Huang et al. (2013) simultaneously tracks the pose and shape of humans by optimising a quadratic energy function that promotes the coherence of neighbouring surface patches. The method proves remarkably effective, although a large pose space is required to describe the high variability in human shape and gesture. Ugolotti and Cagnoni (2013) parametrically describes a deformable body model with 42 parameters: 29 degrees-of-freedom to describe articulated skeletal joints, 7 parameters to specify limb lengths/thicknesses; and 6 parameters describing the relative pose of the model. A similar idea is explored by Lehment et al. (2013) who searches a 22-DOF human pose space using an observation likelihood function approximation whereby point-cloud measurements from a Kinect sensor are compared to the expected point-cloud of a pose hypothesis. Both of these works use parallel processing to search the large pose space in real-time.

It is noted that ‘Where is it’ questions arise in the tracking of robotic end-effectors. Liu et al. (2014) estimates the configuration of an excavator using elastic shape analysis on simulated range measurements. Six geometry models in varying poses encapsulate the machine's geometric form and provide a database of comparable silhouette descriptors. Kashani et al. (2007) extract the joint space of hydraulic-construction excavator using the Iterative Closest Point method (Besl and McKay, 1992) to fit a 2D LiDAR profile to the known geometry of the excavator's bucket. The approach is extended in Kashani et al. (2010) using a particle filter for coarse estimation of a large mining excavator, similar to the machine presented in this paper. Online segmentation is required to remove measurements of the terrain, and the non-rigid dipper door from the laser profile.

‘What/where-is-it’ and ‘is-it-what/where’ questions pose themselves as multiple hypothesis comparisons. A family of potential alternatives are postulated and the hypothesis that is best supported by evidence is selected. This idea is pursued by de Figueiredo et al. (2013) who present a grid-based Bayesian filter for identifying objects and estimating their pose. A hypothesis space, augmented by a 6-DOF pose with a label-specifier, is discretized into 8.1×105 hypotheses. The most likely pose is determined by measuring the evidence for each of the hypotheses that is inferred from point-cloud measurements which are considered to be conditionally independent given the hypothesis state. A similar approach is employed by Su et al. (2013), who uses a likelihood ratio test to detect the occurrence, pose and scale of 2D and 3D geometries in simulated point-cloud measurements. Likelihood maps are generated from a catalogue of geometries to build evidence in determining the type of object most likely to provide the observed point-cloud measurements. CAD models of objects are typically used to encapsulate the a priori geometric information required by these estimation methods (Gunther et al., 2011). An alternative to cataloging geometry models is to describe the potential objects using geometric descriptors. Armbruster and Hammer (2012) identifies different ship types from flash LiDAR measurements using a catalogue of geometric descriptors that parameterise the shape of the hull.

Urban environment classification provides another domain in which ‘where’/‘what’ questions are asked. Autonomous vehicles require ‘where’ information to predict obstacle collisions and both ‘where’ and ‘what’ information to plan suitable avoidance strategies. Urban object types are both numerous and variable. For these reasons geometric information is often encoded by supervised training in preference to a large catalogue of geometry models. Choe et al. (2014) characterizes segmented point-cloud clusters by the angle made between consecutive measurements, e.g. vertical, sloped, scattered. The algorithm is trained to identify when a three-component bivariate Gaussian mixture model of these degrees is similar to that of buildings, trees, cars and curbs. Teichman et al. (2011) presents a classifier that has been trained to identify cars, pedestrians, cyclists, or background objects in an urban environment. Objects are segmented using a connected components algorithm which is facilitated by the fact that objects actively work to stay separated.

Others working in urban environments have taken to object identification by inspecting the distribution characteristics of their point-cloud measurements. Cabo et al. (2014) identifies pole-like objects by searching the measurement set for vertical continuity, whereas, Gao and Yang (2013) detect and segment buildings using the predictable voids created by alleyways. Kim et al. (2013) considers 41 point-cloud characteristics for their discriminatory power in identifying grass, buildings, roads and trees.

The focus of most prior work is on answering ‘What is it?’ or ‘Where is it?’ or both. The present embodiments deal with verification, and in particular the question of ‘Is it what and where I think it is?’. There is a significant gap in the literature around these questions.

### SUMMARY OF THE INVENTION

It is an object of the invention, in its preferred form to provide systems and methods for the automated testing of objects form and pose.

In accordance with a first aspect of the present invention, there is provided a method of determining the location of a candidate object in an environment, the method including the steps of: (a) capturing a 3D point cloud scan of the object and its surrounds; (b) forming a surface geometry model of the candidate object. (c) forming a range hypothesis test comparing an expected range from the geometry model of the candidate object in comparison with the measured range of points in the LiDARpoint cloud scan and deriving an error measure there between; (d) testing the range hypothesis for a series of expected locations for the surface geometry model of the candidate object and determining a likely lowest error measure.

The method can be carried out on a series of different geometry models for different candidate object shapes. The step (d) preferably can include accounting for scan sensor pose and measurement uncertainty in the 3D point cloud scan model.

The 3D point cloud scan can comprise a LiDAR scan of the object and its surrounds. The candidate object can comprise a shovel bucket.

### BRIEF DESCRIPTION OF THE DRAWINGS

Embodiments of the invention will now be described, by way of example only, with reference to the accompanying drawings in which:

FIG. 1 illustrates a photograph of an electric mining shovels used to remove overburden in open-cut mining Under automated control there is potential for high-energy collision between the bucket of the shovel and a truck being loaded.

FIG. 2 illustrates a generic electric mining shovel illustrating the general assembly of an electric mining shovel and related terminology.

FIG. 3 illustrates the 3D LiDAR measurement point-cloud associated with a typical scan used to assist exploration. The unsegmented point-cloud contains measurements of: (i) the dipper and handle assembly; (ii) the dig-face immediately in front of the dipper; and (iii) loose material/debris falling from the dipper. The hypothesised region of space occupied by the shovel's geometry is shown by the outline.

FIG. 4(a) illustrates the Bailpin reachable motion range envelope in the house frame, and FIG. 4(b) illustrates the corresponding Reachable crowd-hoist extension space.

FIG. 5(a) illustrates the LiDAR measurements used to accept the belief of what space is occupied by the dipper geometry. FIG. 5(b) illustrates example LiDAR measurements used to reject the belief of what space is occupied by the dipper geometry.

FIG. 6 illustrates a photo of an actual digger assembly illustrating that some parts of the dipper-handle assembly can not be modelled as a rigid geometry. These includes: (i) bollards that hang from the handle to assist truck operators correctly position; (ii) the damper on the rear of the dipper used to retard door motion; and (iii) the trip cable pulled to release/trip the door. All are imaged by the scanner resulting in model-measurement mismatch.

FIG. 7 illustrates a geometry model of the dipper-handle assembly which is placed relative to the house frame in the position the automation system believes is true. Expected measurements zᵢ, are determined by ray-casting along the sensor rays and comparing with the observed measurements, \hat{z}ᵢ. This is illustrated for the i-th measurement the observed range measurement, zᵢ, is shown to be slightly shorter than the expected range \hat{z}ᵢ.

FIG. 8(a) illustrates range difference plotted over a null hypothesis. Most range measurement differences are close to 0 m in the reported pose. Range measurements of unmodelled geometry are observed to be up to 5 m shorter than expected, while range measurements of the terrain are up to 5 m longer if they were expected to intersect the dipper geometry. FIG. 8(b) illustrates the distribution of range differences. Range measurement differences are distributed about zᵢ.−\hat{z}ᵢ.=0 consistent with the null hypothesis.

FIG. 9 illustrates the mean range difference μ. FIG. 9(a) shows the average range difference is close to 0 m where the true pose lies (as shown by the ‘+’ marker), but is also low in poses that are grossly incorrect. The standard deviation in the sample range differences is illustrated in FIG. 9(b) generally increases with pose error. The number of intersecting rays is illustrated in FIG. 9(c) which provides a sufficient sample size for the application of the z-test over the full pose hypothesis space.

FIG. 10 illustrates most dipper-handle pose hypotheses produce a z-score indicating that the observed mean range difference, μ, has less than a 5% chance of occurring under the null hypothesis. This is a very strong indication that these poses hypotheses should be rejected. The null hypothesis is shown to be accepted for a thin band of dipper poses when the same significance level of a=5% is used to reject. The true pose shown by the ‘+’ is rejected, yet a grossly inaccurate pose hypothesis, indicated by the ‘x’ is accepted.

FIG. 11 illustrates false positives occurs when the null hypothesis is accepted but should have been rejected. The position of the dipper-handle assembly in this hypothesis is far from the true location, yet the mean range difference is only 0.0017 m. This consequently results in the null hypothesis being incorrectly accepted.

FIG. 12 illustrates the dipper moves in such a way that the most displaced part of the geometry will be either the tip of the front teeth or the door latch. The two ellipses show the envelope of crowd-hoist error made by displacing the tooth and latch 0.2 m The intersection of these two ellipses defines a region in the crowd-hoist error space that would acceptably place the geometry such that no part is displaced more than 0.2 m from what the automation system believes.

FIG. 13 illustrates the individual measurements providing limited evidence in support of the null hypothesis. As a collective, however, the likelihood of the observations is much higher for the null hypothesis FIG. 13(a) than it is for the alternate FIG. 13(b).

FIG. 14 illustrates the reported pose positions placing the dipper geometry within 0.2 m of its true location. 23 of these were incorrectly identified as out-of-tolerance and are shown by the false positive markers. 14 of the 220 out-of-tolerance poses were incorrectly accepted as being within tolerance and are shown by the false negative markers. The number in each cell is the maximum displacement of the geometry between the reported pose \hat{x} and the true pose x.

FIG. 15 illustrates the results from FIG. 14 plotted against the bailpin to provide perspective on the magnitude of these deviations relative to the scale of the machine.

FIG. 16 illustrates in FIG. 16(a) the measurements that are very likely obtained by the correct hypothesis. FIG. 16(b) a hypothesis that the dipper is 0.1 m forward of the true position making it less likely that we would observe the range measurements provided by the sensor. FIG. 16(c) illustrates a further 0.1 m crowd error shows that the measurements are even less likely. FIG. 16(d) illustrates the hypothesis is augmented to include the dipper-door angle. It is unlikely that the measurements on the door would be observed under a hypothesis that the door is open. Measurements that provide no evidence in favour of the hypothesis, such as those on the terrain, are shown as small black dots.

FIG. 17 illustrates a plot of 10001 pose hypotheses obtained by discretising the joint space at 0.1 m resolution. Normalising the aggregating m measurements likelihoods for each hypothesis reveals that the hypothesis, \hat{x}=[9.4 m, 11.7 m], is most likely to provide the range measurements. This estimate is the closest hypothesis to the true pose of the dipper (or at least, what is believed to be the true pose).

FIG. 18 illustrates the most likely pose of the correct geometry model. FIG. 18(a) is much more likely than any other hypotheses over the discretised work space, as shown in FIG. 18(c). An incorrect dipper geometry, in this case a beach-ball FIG. 18(b), has the same most likely hypothesis but it is not nearly as dominant as shown in FIG. 18(d).

FIG. 19 illustrates the estimate of the dipper likely to have its pitch-brace length changed or even be changed out for one of a different size. FIG. 19(a) illustrates pose estimates of these incorrect geometry models are shown to disagree with the reported crowd-hoist pose of the dipper and would result in triggering of the safety function. Should a model have been estimated in the correct location, it can still be identified for rejection by the low peak in the accumulated likelihood map FIG. 19(b) and FIG. 19(c).

### DETAILED DESCRIPTION

The embodiments seek to provide a framework by which the truth or otherwise of is-it-what-and-where-I-think-it-is questions can be reliably established from point-cloud data, e.g. the data from high-density high rate scanners such as the Velodyne HDL-64E. The asker of these questions is an automation system that uses a model of the world to plan and execute safe motions of the equipment under its control. The automation system asks these questions to verify the world model, typically using sensor measurements independent of those used in constructing the world model.

This verification is performed as part of a systematic strategy to achieve safer operation consistent with the concept of a diagnostic test as set out, for example, in the standard IEC 61508 (IEC, 2011). Specifically, the automation system takes actions needed to maintain a safe operating state if it is established that the measured world is sufficiently different from the model.

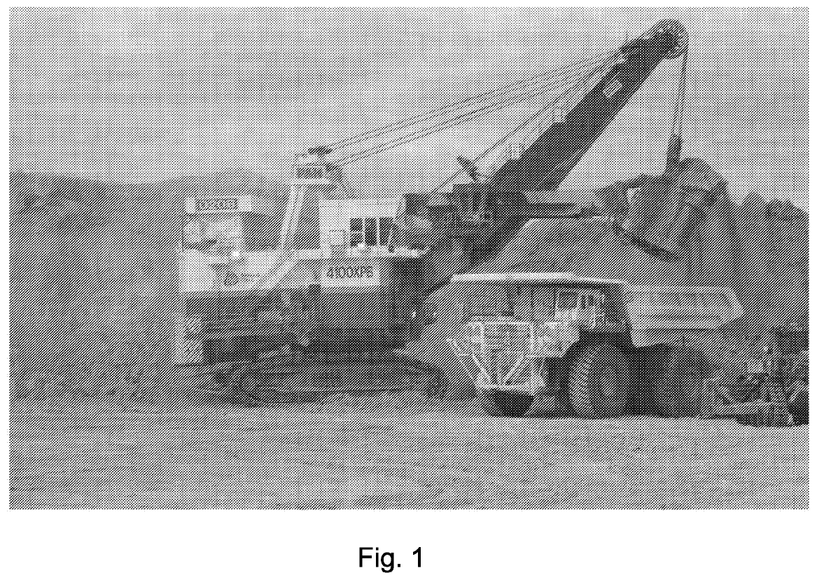

The embodiments are especially suitable for operation in the automation of surface mining equipment, specifically electric mining shovels of the sort shown in FIG. 1, whose function is to excavate material and load trucks for transport to dump areas of stockpiles. The need for diagnostic tests that answer is-it-what-and-where-I-think-it-is questions have arisen from an identified need for engineering controls to reduce the risk of high-energy collision should either the truck or the shovel not occupy the regions of space the automation system believes they occupy.

In an example embodiment, verification that the a shovel's bucket (a.k.a. “the dipper”) occupies the region of space it is thought to is targeted. However, the ideas explored apply, either directly or with appropriate adaptation, to other instances where an automation system must test it's knowledge of the geometric form and location of objects.

The embodiments are heavily influenced by the framework of functional safety, viz. standards IEC 61508 and IEC 62061, seen by the regulators of the Australian mining industry (among other jurisdictions) as an overarching scaffold for the implementation of advanced mining automation systems. Among other things, this requires the development of effective diagnostic tests to identify dangerous failures caused by hardware and software design, and control failures due to environmental stress or influences including those associated with system configuration.

Dipper Verification

In the embodiments, the focus is on detecting the dangerous failure that arises when the dipper of an electric mining shovel occupies regions of space different to that which the automation system believes it occupies.

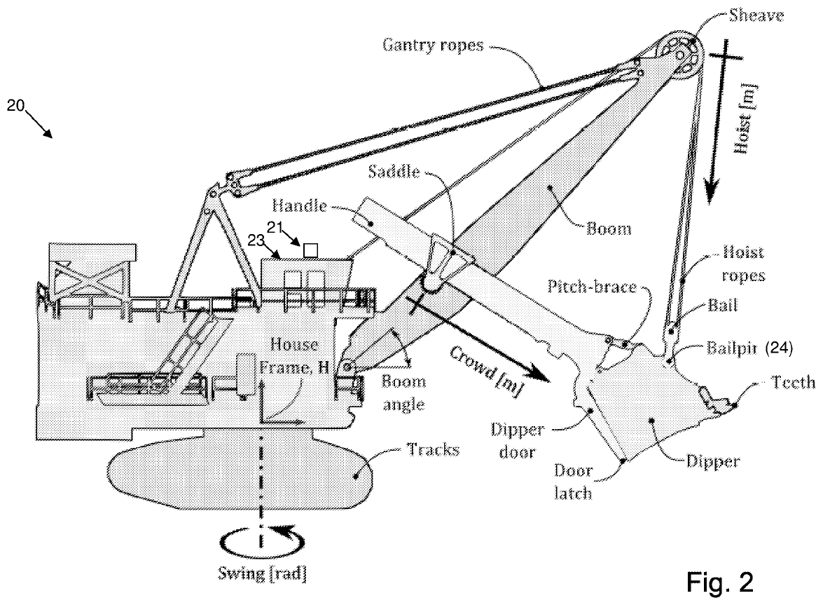

FIG. 2, by way of background, illustrates the general layout 20 of an electric mining shovel and sets out exemplary terminology. The spatial position of the dipper is controlled by the through swing, crowd and hoist motions. Resolvers fitted to the actuators associated with these motions measure hoist and crowd extensions and swing angle. The automation system normally knows where the dipper is through a kinematic model describing the front-end geometry of the machine. Knowledge of the space occupied by the dipper-handle assembly is determined by overlaying the geometry model of the assembly at this location. The indirect measurement of dipper position through sensors collocated with the actuators supports robust implementation of low level control functions but increases the likelihood of dangerous failure to the chain of inference required to convert motor resolver readings into the space the dipper occupies.

The embodiments provide for using data from a scanning LiDAR sensor 22 (Velodyne HDL-64E) fixed to the machine house 23. The sensor provides 3D point-clouds at 20 Hz (Velodyne LiDAR Inc, 2008). The primary function of this sensor is imaging terrain and objects in the workspace including trucks, bulldozers, and ancillary equipment, however its placement is arranged to capture dipper position.

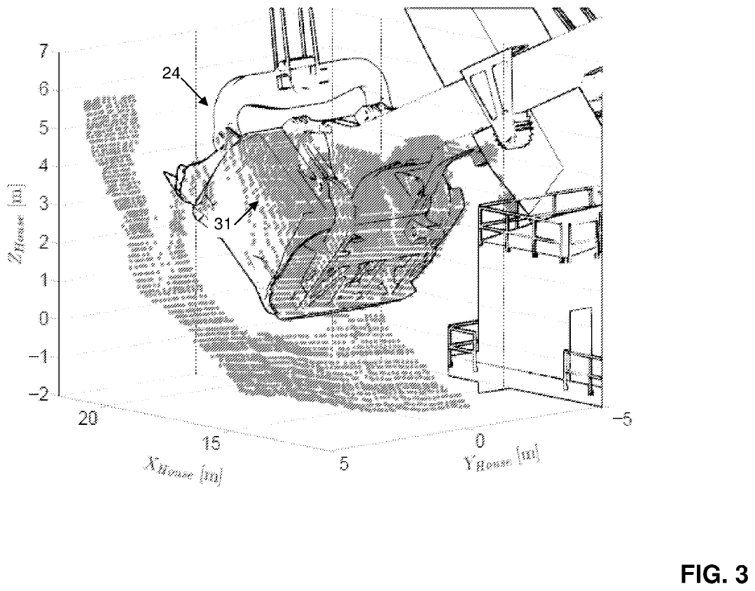

FIG. 3 illustrates an example point-cloud associated with a typical scan. The sensor provides a potential independent (of the resolvers) measurement of the position and geometric form of the dipper and handle. As the Velodyne sensor is fitted to the machine house, dangerous failures associated with errors in swing are not detectable. In practice swing motions are not at the cause of the most important failures.

The position of the bailpin 24 in the plane of the boom is used to describe the location of the dipper relative to the machine house.

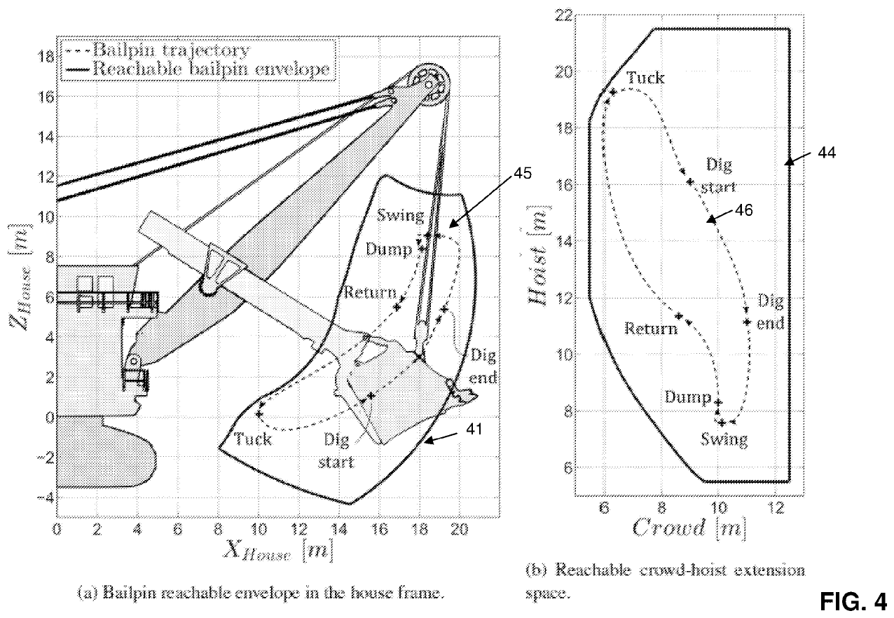

FIG. 4a shows the reachable envelope 41 for the bailpin and FIG. 4b shows the associated crowd and hoist extensions 44. Motion of the bailpin through a typical loading cycle is indicated 45, 46.

The failure the embodiments seek detect has several potential causes, including:

1. Bias in the crowd and hoist extensions. The crowd extension becomes biased when the crowd transmission slips. The hoist extension becomes biased whenever the hoist ropes are changed out and a new rope installed.

2. Mismatch between the kinematic reference and the machine geometry. For example, the length of the pitch-brace is occasionally altered to optimise the rake angle of the dipper teeth without knowledge of this change being updated to the internal model. Similarly, the gantry ropes stretch over time, altering the boom angle.

3. The dipper is occasionally changed for one that is bigger or smaller or otherwise better suited to the current digging conditions.

These causes are classifiable as (i) systemic issues associated with operation of the machine, e.g. boom angle change due to rope stretch, and (ii) issues linked to configuration management of information required by the automation system, e g maintaining the correct internal representation of the dipper. The complex socio-technical environment of open-cut mining and the potential for causes to compound, makes management of these issues challenging. For instance, the decision to replace the dipper with an alternative may or may not trigger the requirement to update the automation system's model of the dipper's geometry depending on site workflows and adherence to them. Alternatively, slippage of the crowd transmission is a consequence of machine design and is not detectable using the existing suite of sensors fitted to the machine. Neither affects current manual machine operation. However, under automation, it is necessary to identify when the failure has become sufficiently dangerous to require address.

Is-it-What-and-Where Verification is Hypothesis Testing

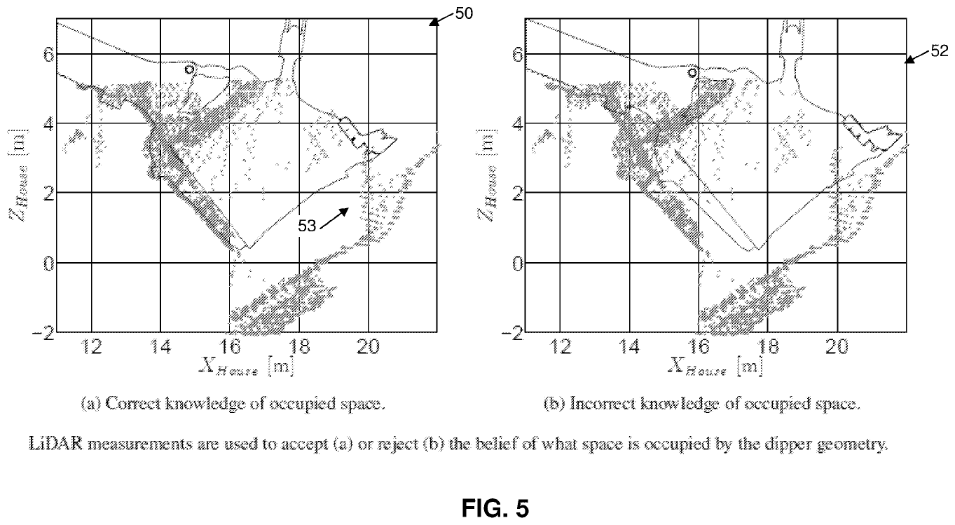

FIG. 5a shows measured point-cloud data 50 superimposed on where the dipper and handle is thought to lie. The two are seen to be in good agreement. In contradistinction, FIG. 5b shows poor agreement 52 because the crowd and hoist extensions are biased. Visual inspection suggests accepting the proposition that the dipper is what and where the automation system thinks for FIG. 5a and rejecting this proposition for FIG. 5b. The embodiments seek to establish these same conclusions reliably by analytic tests. Importantly, the tests must deliver minimum false positives and false negatives in the presence of measurement noise and model mismatch.

There are several points to note about the point-cloud and geometry model used as the basis for comparison in FIGS. 5a and 5b. Specifically: (i) the point-cloud includes points that are not on the dipper, here terrain including dirt seen falling from the teeth 53, 54; (ii) the point-cloud does not provide a complete scan of the dipper with the upper most points being at the top of the sensors field of view; (iii) the model against which the comparison is made is not a perfect representation of the dipper and handle; and (iv) the point-cloud measurements are subject to error. Verification testing amounts to determining whether, in the presence of these complications, the agreement between the internal representation of the object in question and point-cloud measurement of that object is sufficiently good to accept the proposition that it has the correct form and is in the understood spatial location.

At one level, the task amounts to distinguishing between two views about the world: the object of interest occupies the region of space we believe it occupies or the region of space it does occupy is sufficiently different from what is believed such that it presents a dangerous situation.

The first view forms our null hypothesis, H₀ and the second, the alternative hypothesis Hₐ. The challenge lies in how to reliably distinguish between the two. The answer can come down to applying Bayes' theorem, (Bayes and Price 1763), however there are many subtleties to this problem that warrant specific attention.

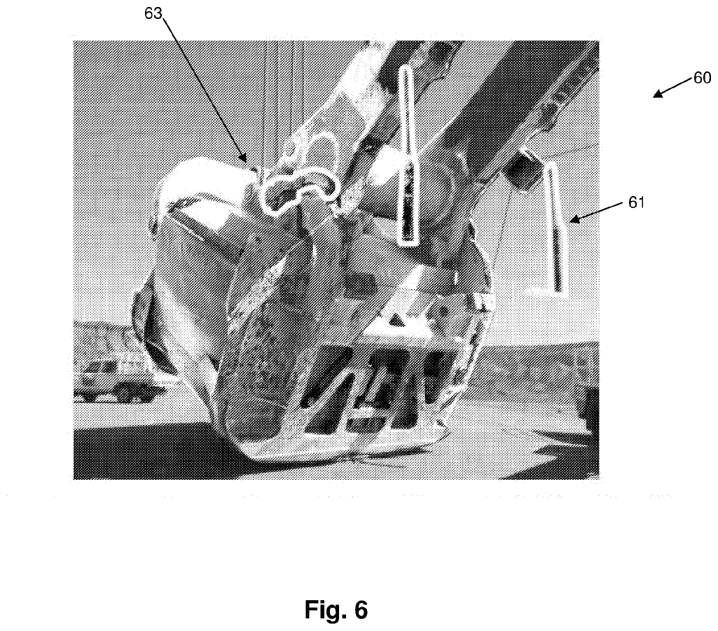

FIG. 6 illustrates some parts of the dipper-handle assembly which cannot be modelled as rigid geometry. These include: (i) bollards e.g. 61 that hang from the handle to assist truck operators correctly position; (ii) the damper 63 on the rear of the dipper used to retard door motion; and (iii) the trip cable pulled to release/trip the door. All are imaged by the scanner resulting in some model-measurement mismatch.

Can Classical Hypothesis Testing be Used for Verification?

Classical hypothesis testing normally involves devising a test statistic, apportioned between a null hypothesis and an alternative hypothesis, and asking where the value of this statistic lies in the distribution implied by a null hypothesis.

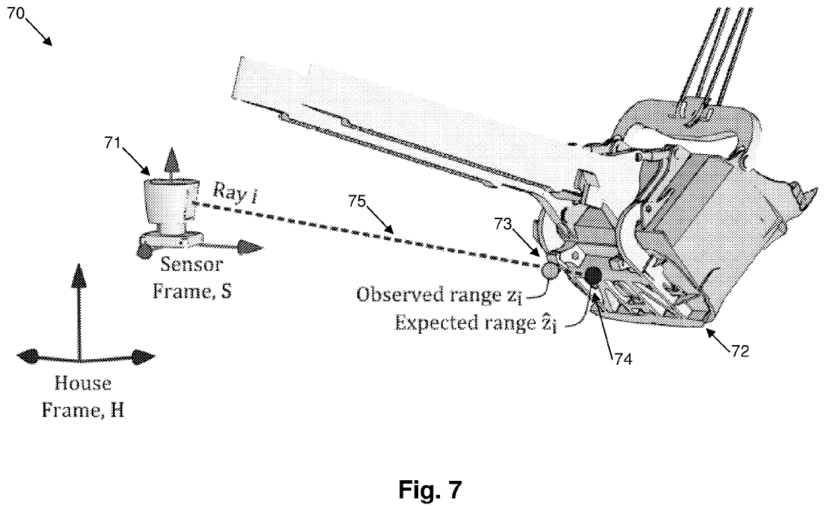

An appropriate statistic follows from FIG. 7, which depicts the geometry of measurement 70. Each sensor measurement, zᵢ 73, is a range measurement along a known sensor ray 75 that can be compared to an expected range, \hat{z}ᵢ 74, found by ray-casting against a geometry model of the dipper-handle assembly 72 in the position the automation system believes is correct. The Velodyne HDL-64E 71 typically returns 2000 to 7000 points in the region that can be occupied by the dipper with approximately 500 to 3000 of these intersecting the dipper-handle assembly, depending on its position in the workspace. The difference between the expected range and measurement quantifies the extent to which points on the dipper-handle assembly are not where they are thought to be. The average difference over all sensor rays expected to intersect the dipper-handle is:

$$μ = \frac{{\sum }_{i = 1}^{n} {z}_{i} - {\hat{z}}_{i}}{n} , \qquad ( 1 )$$

where n is the number of sensor rays expected (from the ray-cast) to give returns from the dipper-handle assembly. The null and alternative hypothesis can be expressed in terms of μ,

H₀: μ=0, (2)

Hₐ: μ≠0, (3)

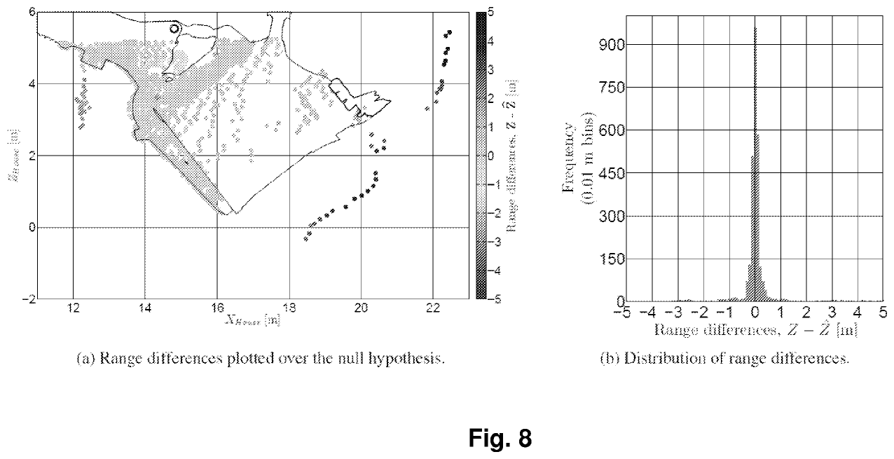

FIG. 8a shows the range measurement differences for sensor rays expected to intersect with a dipper-handle assembly that has geometry consistent with the automation system's internal model and has its position known to within resolution of the calibration method used to determine offsets that account for bias on hoist and crowd extensions. For all intents and purposes, in this data, the dipper-handle assembly is what and where the automation system believes it is and an effective diagnostic test should verify this. The distribution of range differences for sensor rays expected to intersect the dipper and handle is shown in FIG. 8b. The 2695 rays expected to return points on the dipper and handle have mean range difference, μ=0.027 m and standard deviation s=0.535 m. The standard deviation is biased by some large outliers due to incorrect model geometry.

Using a ‘plug-in’ z-test (Ross, 2010) gives:

$$z = \frac{μ - 0}{s / \sqrt{n}} = \frac{0.027}{0.535 / \sqrt{2695}} = 2.66 . \qquad ( 4 )$$

For a significance level α=0.05, application of the z-test leads to rejection of the null hypothesis (acceptance would require a z-score in the range −1.96<z<1.96). The test wrongly fails because it judges the likelihood of the null hypothesis to be small while ignoring the alternative hypothesis which transpires to be even less likely. Using the power of the test (the likelihood of rejecting the null under the alternative) would bring additional clarity, but the point to be emphasized is that a z-score that is unlikely under the null does not ipso facto imply that the null must be unlikely or that the alternative is more likely. The misinterpretation of low probability has been referred to as the “illusion of probabilistic proof by contradiction” (Falk and Greenbaum, 1995). What matters is the relative weight of the evidence in support of the null, not the probability of the test statistic given the null.

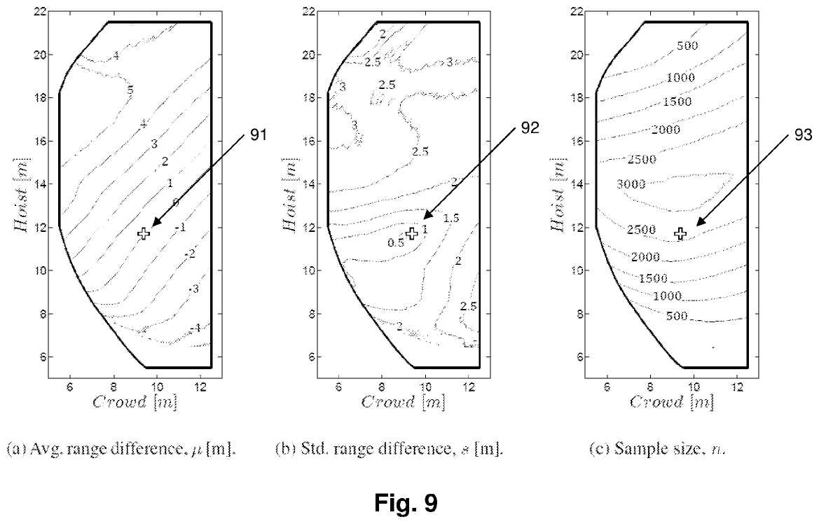

To better understanding, FIG. 9 shows how μ, s, and the number of expected intersecting rays varies with the dipper position, mapped into crowd-hoist extension space. The dipper position, as known to the automation system, is shown by the cross-hair and, as expected, lies close to the μ=0 contour and near minimum value of s. With perfect measurement, exact knowledge of dipper position, a perfect model of the dipper against which comparison is made, and the absence of other factors influencing measurements, the cross-hair would lie on μ=0 and s=0.

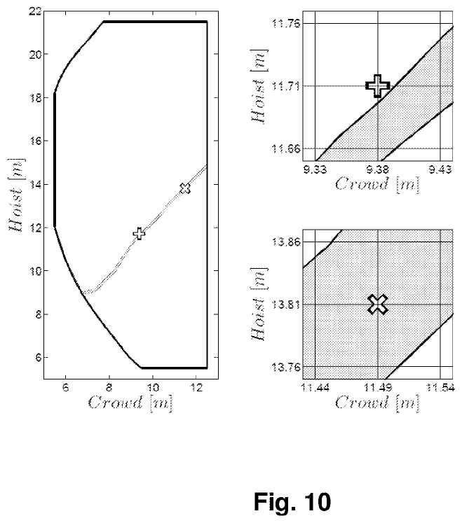

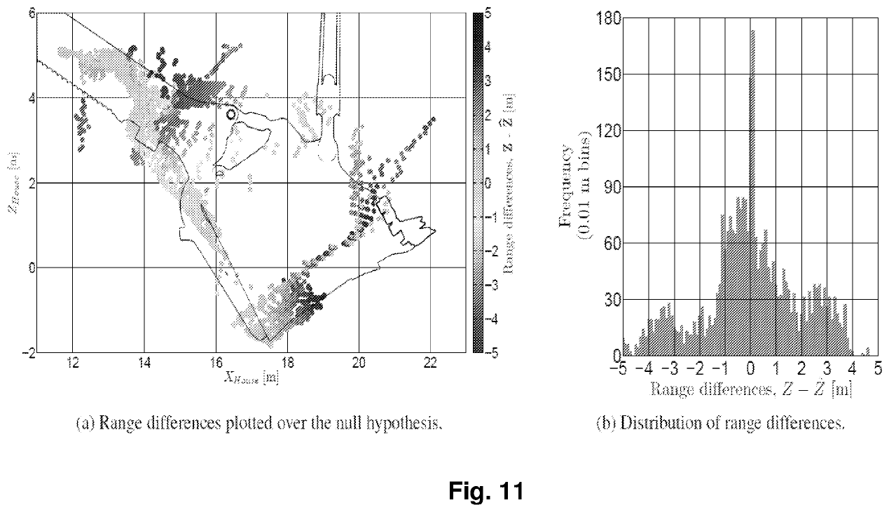

A collection of crowd-hoist combinations within a band centered on the μ=0 contour share the property that they do not lead to rejection of the null hypothesis. Yet a small deviation from the correct pose outside this band does. FIG. 10 shows the acceptance band in the extension space that corresponds to observing the candidate point-cloud measurements. The null hypothesis would not have been rejected if either the crowd or hoist were 0.01 m from the values as measured by the motor resolvers. Running counter to this, FIG. 10 shows a crowd-hoist configuration that would be accepted by a z-test, leading to a false positive. The hypothesis and corresponding distribution of range differences for this false positive is shown in FIG. 11. This example illustrates that if classical hypothesis testing is used, it is entirely possible to strongly reject the null where the null is more likely than the alternative, and vice versa.

Choosing Between Hypotheses Requires Invoking Bayes' Theorem

A criticism of classical hypothesis testing is that it computes the probability of measurements given the null is true P(z|H₀) rather than what is required, namely the probability of the null given measurements, P(Hₒ|z), (see Cohen 1995). The two are related by Bayes' theorem which provides a method for assessing relative probabilities. It is possible to compute P(H₀|z) by application of Bayes' theorem. Invoking Bayes' theorem provides additional benefit in that it allows the null to be expressed as a margin of tolerance. This is more consistent with the spirit of the intended diagnostic test which is to establish if the automation system's understanding of the space occupied is close enough to the actual space occupied so as to not cause unintended collision. The null and alternative can be expressed as

H₀: ∥pₖ−\hat{p}ₖ∥≤τ,∀k, (5)

Hₐ: ∥pₖ−\hat{p}ₖ∥>τ,∃k, (6)

where pₖϵP is the set of all point on the dipper and \hat{p}ₖ ϵ\hat{P} the corresponding points in the automation system's representation. The tolerance, τ, describes the maximum allowable deviation of any part of the geometry wherein the failure remains safe. In practice, deviations from this tolerance band occur at the “extremities” namely at the dipper teeth or at the door latch (as per FIG. 2).

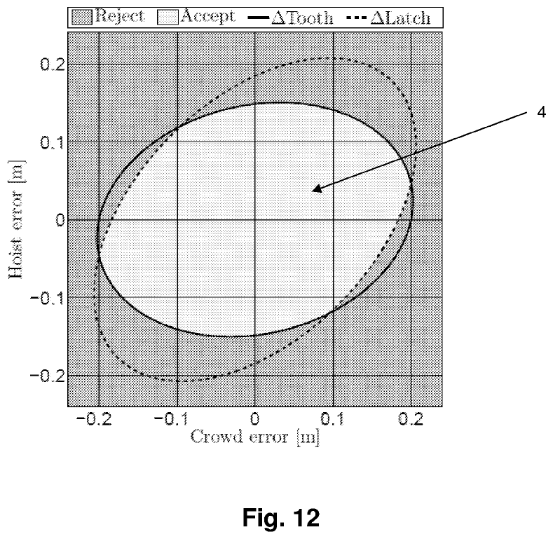

A dangerous failure tolerance of τ=0.2 m was utilised in practice. This value was chosen based on observations of how close operators typically come to trucks in safe loading cycles. The null hypothesis can now be (informally) stated as “the believed position of the front dipper teeth and latch are within 0.2 m of their true location”. This region of acceptable geometric error can be mapped to acceptable crowd-hoist error as shown in FIG. 12.

Deriving a Measurement Likelihood Driven Test Statistic

Bayes' theorem states:

$$P ( {H}_{0} \vert z ) = \frac{P ( z \vert {H}_{0} ) \cdot P ( {H}_{0} )}{P ( z )} = \frac{f ( z \vert {H}_{0} ) \cdot P ( {H}_{0} )}{f ( z )} , \qquad ( 7 )$$

where ƒ(z|Hₒ) is the conditional likelihood of observing the range measurements under the null hypothesis, P(H₀) is the prior probability of the null hypothesis and ƒ(z) is the probability density function of range measurements.

Using the total probability theorem, ƒ(z) can be written as:

ƒ(z)=ƒ(z|H₀)·P(H₀)+ƒ(z|Hₐ)·P(Hₐ), (8)

which may be rearranged to provide an expression for the prior probability of the alternate hypothesis,

$$P ( {H}_{a} ) = \frac{f ( z ) - f ( z \vert {H}_{0} ) \cdot P ( {H}_{0} )}{f ( z \vert {H}_{a} )} , \qquad ( 9 )$$

the complement of which provides an expression for the prior probability of the null hypothesis, P(H₀):

$$\begin{matrix}P ( {H}_{0} ) = 1 - P ( {H}_{a} ) , ( 10 ) \\ = 1 - \frac{f ( z ) - f ( z \vert {H}_{0} ) \cdot P ( {H}_{0} )}{f ( z \vert {H}_{a} )} , ( 11 ) \\ = \frac{f ( z \vert {H}_{a} ) - f ( z )}{f ( z \vert {H}_{a} ) - f ( z \vert {H}_{0} )} . ( 12 ) \end{matrix}$$

Substituting this expression for the prior probability of the null hypothesis, P(H₀), back into Eqn. 7, allows for the posterior conditional probability of the null hypothesis to be described entirely from the three range pdfs, ƒ(z), ƒ(z|H₀) and ƒ(z|Hₐ):

$$P ( {H}_{0} \vert z ) = \frac{f ( z \vert {H}_{0} ) \cdot ( f ( z \vert {H}_{a} ) - f ( z ) )}{f ( z ) \cdot ( f ( z \vert {H}_{a} ) - f ( z \vert {H}_{0} ) )} . \qquad ( 13 )$$

It is desirable to determine the likelihood of observing the range measurements, z, and the conditional likelihood of observing them if the dipper geometry is in tolerance (H₀) or out of tolerance (Hₐ).

Assessing Univariate Measurement Likelihood

A strategy for estimating the measurement pdfs on a ray-by-ray basis can be provided as follows. The measurement pdfs in Eqn. 13 are non-parametric distributions that describe the likelihood of observing range measurements along the ray trajectories they are assumed to be measured on. Considering the likelihood of an independent measurement, as observed on the i-th ray by approximating the range probability density function using kernel density estimation (Silverman, 1986). The estimated range pdf, \hat{ƒ}(zᵢ), of the i-th range measurement is obtained by sampling ray-casts against the dipper-handle geometry in perturbed poses of the workspace. The crowd-hoist workspace is uniformly sampled by applying perturbations, Δx, to the crowd-hoist extensions \hat{x} as known to the automation system. This ray-casting operation described is denoted r(⋅), and the expected range for the i-th measurement against the k-th perturbation as:

\hat{z}_{i,k}=rᵢ(\hat{x}+Δxₖ). (14)

The range pdf of the i-th measurement is approximated from a collection of N ray-casts, {\hat{z}_{i,k}}ₖ₌₁^{N} and the kernel density estimator approximates the range measurement pdf as the summation of a kernel function, K(⋅), located at each of these ray-casted positions,

$$\hat{f} ( {z}_{i} ) = \frac{1}{N \cdot h} {\sum }_{k = 1}^{N} K ( \frac{{z}_{i} - {\hat{z}}_{i , k}}{h} ) . \qquad ( 15 )$$

The term h, known as the bandwidth, acts as a smoothing parameter that provides a trade-off between the bias and variance of the estimator. Using Gaussian distributions for the kernel function,

$$K ( x ) = \frac{1}{\sqrt{2 π}} \cdot {e}^{\frac{- {x}^{2}}{2}} , \qquad ( 16 )$$

an appropriate selection for the bandwidth, h, is chosen dynamically to suit the sample data using:

$$h = {( \frac{4 {\hat{σ}}^{5}}{3 N} )}^{1 / 5} , \qquad ( 17 )$$

where \hat{σ} is the standard deviation of the sampled range ray-casts. This bandwidth, known as Silverman's rule of thumb after Silverman (1986), is optimal for normally distributed sample data. It is chosen here over a constant bandwidth because the variance of the sampled ray-cast measurements is unpredictable.

The conditional probability density functions, \hat{ƒ}(zᵢ|H₀), \hat{ƒ}(zᵢ|Hₐ), can be approximated using only those ray-casts where the tolerance on geometry displacement is satisfied and unsatisfied respectively (i.e. uniformly sampling inside and outside of the region 121 in FIG. 12). The three range pdfs, \hat{ƒ}(zᵢ|H₀), \hat{ƒ}(zᵢ|Hₐ), \hat{ƒ}(zᵢ|H₀), and \hat{ƒ}(zᵢ), can be respectively approximated using N=1000 in-tolerance dipper poses, N=1000 out-of-tolerance dipper poses, and N=1000 tolerance-irrespective dipper poses.

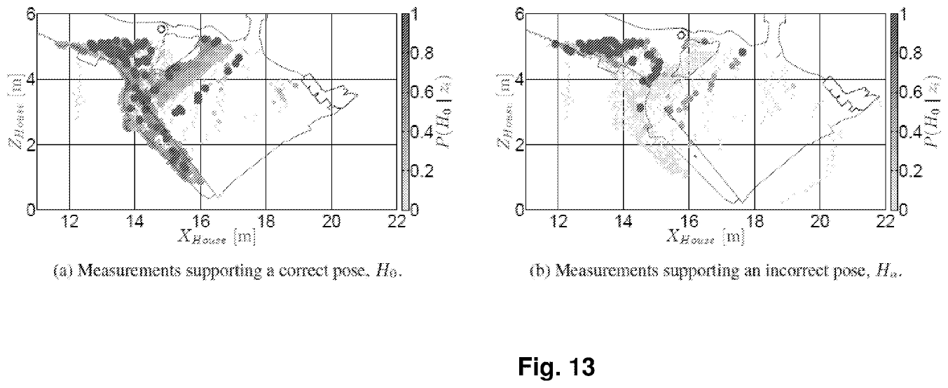

Equation 13 can provide a univariate probability of the null hypothesis, P(H₀|zᵢ), for each of the independent measurements as shown in FIG. 13. A single measurement provides little evidence to select one hypothesis over the other, in fact, the average probability from these measurements is only 36.55%. However, the cumulative evidence over all rays paints a very polarising picture. As Sturrock (1994) puts it “extraordinary evidence can be built up from many (but not very many) items of unspectacular evidence, provided the items are truly independent”.

The approximated range density functions are driven purely by the dipper-handle geometry and assume no uncertainty in the pose of the sensor, T_{H→S}, or measurement uncertainty of the sensor itself. The samples used to construct the range pdfs can incorporate both of these uncertainties by replacing the ‘ideal’ ray-casting function (Eqn. 14) with:

\hat{z}_{i,k}=rᵢ(\hat{x}+Δxₖ,wₖ)+vₖ, (18)

where wₖ is a deviation made to the sensor registration prior to ray-casting and vₖ is a sensor measurement error added to the ray-cast result. The Velodyne HDL-64E has a sensor measurement uncertainty (1σₛₑₙₛₒᵣ) of 20 mm (Velodyne LiDAR Inc, 2008), hence vₖ is about N(0, σ²ₛₑₙₛₒᵣ). A previous study in registering this sensor to mining platforms found that the registration parameters could be recovered within 1σ uncertainties of approximately 10 mm and 1 mrad in position and orientation respectively (Phillips et al., 2014). The deviation to sensor pose is drawn from this parameter covariance, i.e. wₖ˜N(0, Cov(T_{H→S})).

Adding sensor pose and measurement uncertainty to the ray-casting function dilates the estimated range pdfs. Consequently, the test statistic's ability to identify incorrectly reported geometry poses is reduced for hypotheses near the τ=0.2 m tolerable boundary. Measurement error can bias the test to reject the null hypothesis if it is interpreted as evidence towards the alternative hypothesis and vice versa. Without these uncertainties, however, the test statistic would be asking the likelihood of observing inaccurate measurements given where they would ideally be located. This would result in the incorrect rejection of many valid reported poses, i.e. spurious trips.

Evaluating the Test Statistic from the Joint Measurement Likelihoods

The multivariate densities, ƒ(z), ƒ(z|H₀) and ƒ(z|Hₐ) are required in Eqn. 13 to compute the conditional probability of the null hypothesis, P(H₀|z). The joint probability function can be determined from the univariate kernel density approximations presented in the previous section:

$$\hat{f} ( z ) = {\prod }_{i = 1}^{n} \hat{f} ( {z}_{i} ) , \qquad ( 19 )$$

where n is the number of range measurements. Equation 19 is similarly used to calculate the conditional joint pdfs, \hat{ƒ}(zᵢ|H₀), \hat{ƒ}(zᵢ|Hₐ).

A characteristic of Eqn. 19 that limits practical usefulness is that the joint pdf will be zero if any of the univariate pdfs are zero. So if a single range measurement is impossible to attain under tolerance (i.e. \hat{ƒ}(zᵢ|H₀)=0), then the null hypothesis will be rejected. Similarly the alternative hypothesis cannot be true if a range measurement cannot be attained from out of tolerance poses (i.e. \hat{ƒ}(zᵢ|Hₐ).=0). To overcome these limitations:

\hat{ƒ}(zᵢ)=max(\hat{ƒ}(zᵢ),ε), (20)

where ε is a tolerance on the minimum allowable probability density.

The test statistic is evaluated using the estimated joint pdfs as:

$$P ( {H}_{0} \vert z ) = \frac{\hat{f} ( z \vert {H}_{0} ) \cdot ( \hat{f} ( z \vert {H}_{a} ) - \hat{f} ( z ) )}{\hat{f} ( z ) \cdot ( \hat{f} ( z \vert {H}_{a} ) - \hat{f} ( z \vert {H}_{0} ) )} . \qquad ( 21 )$$

One of two conditions must be true for the test statistic probability to lie in the range [0→1],

\hat{ƒ}(z|H₀)≤\hat{ƒ}(z)≤\hat{ƒ}(z|Hₐ), (22)

\hat{ƒ}(z|Hₐ)≤\hat{ƒ}(z)≤\hat{ƒ}(z|H₀), (23)

One of these two conditions will always be met by the true density values, however, the product of the kernel density estimated likelihoods may result in \hat{ƒ}(z) no longer being between the likelihood of the null and alternative hypotheses. This typically occurs at the τ=0.2 m boundary where the null and alternative hypotheses intersect. A substitute scheme for computing P(H₀|z) is proposed for this circumstance. The prior probability, P(H₀), can be estimated such that the residual difference of the total probability is minimised:

$${min}_{\hat{P} ( {H}_{0} )} S = {\sum }_{i = 1}^{n} {r}_{i}^{2} , \qquad ( 24 )$$

where the residual, rᵢ is calculated as the estimate error of the total probability for the i-th ray, given an estimate of the prior probability,

rᵢ=\hat{ƒ}(zᵢ)−(\hat{ƒ}(zᵢ|H₀)·\hat{P}(H₀)+\hat{ƒ}(zᵢ|Hₐ)·(1−\hat{P}(H₀))). (25)

A linear least squares minimization of Eqn. 24 yields an estimate of the prior probability:

$$\hat{P} ( {H}_{0} ) = \frac{{\sum }_{i = 1}^{n} ( \hat{f} ( {z}_{i} ) - \hat{f} ( {z}_{i} \vert {H}_{0} ) ) \cdot ( \hat{f} ( {z}_{i} \vert {H}_{0} ) - \hat{f} ( {z}_{i} \vert {H}_{a} ) ) )}{{\sum }_{i = 1}^{n} ( ( \hat{f} ( {z}_{i} \vert {H}_{0} ) - \hat{f} ( {z}_{i} \vert {H}_{a} ) ) \cdot ( \hat{f} ( {z}_{i} \vert {H}_{0} ) - \hat{f} ( {z}_{i} \vert {H}_{a} ) ) )} , \qquad ( 26 )$$

which may be used to approximate the verification statistic in Eqn. 21:

$$P ( {H}_{0} \vert z ) = \frac{\hat{f} ( z \vert {H}_{0} ) \cdot \hat{P} ( {H}_{0} )}{\hat{f} ( z \vert {H}_{0} ) - \hat{P} ( {H}_{0} ) + \hat{f} ( z \vert {H}_{a} ) \cdot ( 1 - \hat{P} ( {H}_{0} ) )} . \qquad ( 27 )$$

This gives a useful alternative verification strategy that guarantees P(H₀)ϵ[0→1] when neither Eqn 22 or 23 are met.

Experimental Verification Results

The Bayesian verification statistic was evaluated on the running experimental data set using 361 reported poses. The error in the reported poses are at 0.025 m intervals of the workspace up to ±0.225 m of the true crowd-hoist position. The process of verification requires that the calculated conditional probability of the null hypothesis, P(H₀|z), is compared against a threshold probability considered to be both acceptable and chosen to provide minimal false positives and negatives. The large number of measurements provide a lot of evidence either in favour of, or against, the null hypothesis. Consequently, the test statistic (Eqn. 21) reported very polarised beliefs regarding the probability of the null hypothesis. 259 of the 341 tests reported the null hypothesis as certain (exactly 100%) or impossible (exactly 0%). The highest calculated probability (that was not 100%) was 0.018% which suggests that, under this statistic, the acceptance of the null hypothesis is not sensitive to the choice of an acceptance threshold.

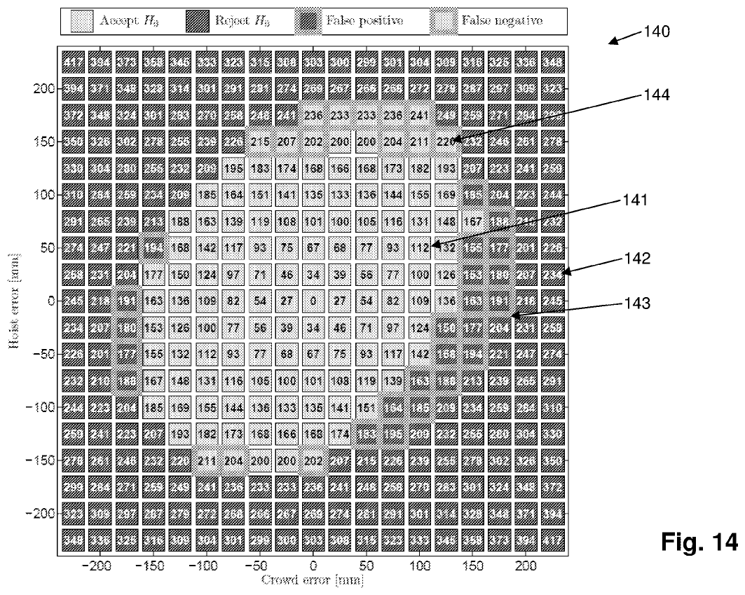

FIG. 14 shows the verification results 140 for the reported poses. The light cells 141 indicate where the test statistic has accepted the null hypothesis; poses that have been rejected are indicated by dark cells 142. The maximum displacement of the geometry is indicated by the number in each cell. Type I and Type II errors can be seen around the i=0.2 m tolerance boundary. FIG. 14 shows the location of Type I errors, or false positives e.g. 143, where the null hypothesis has been rejected even though there is no part of the dipper-geometry that is displaced in excess of 0.2 m. From a diagnostic test perspective, these would result in the spurious activation of a safety function. The average displacement of the dipper during a spurious trip is 0.178 m with the worst case occurring at a displacement of 0.150 m. Type II errors e.g. 144, are also found to appear on the tolerance boundary. These cases are representative of a scenario where the safety system has not been able to detect that the dipper-geometry has a maximum displacement error in excess of 0.2 m. These cases represent dangerous failures, as the inaction of the required safety function could propagate to unacceptable consequences. The average displacement of the dipper resulting in a dangerous failure is 0.218 m with the worst case occurring at a displacement of 0.241 m.

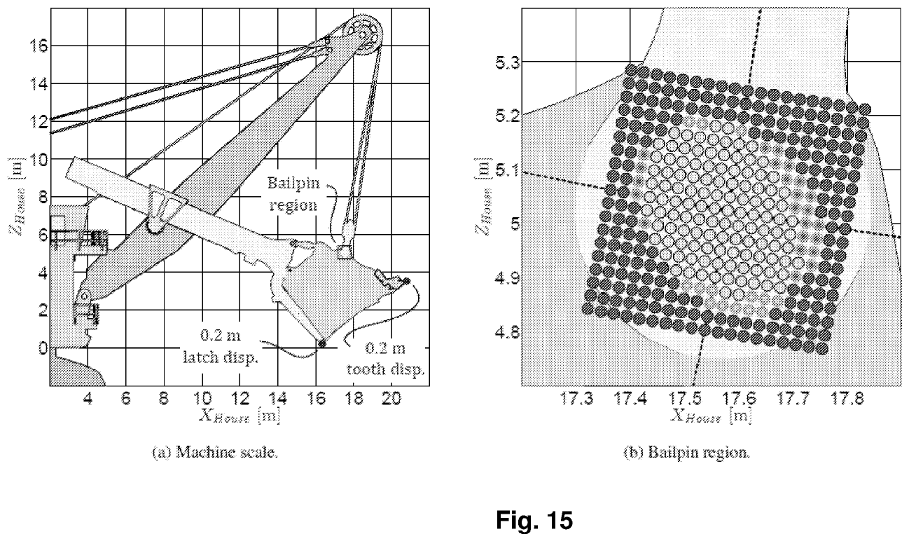

FIG. 15 maps the reported extensions against the bailpin position to provide perspective on the magnitude of their deviations from the true pose. The 0.2 m boundary is difficult to establish on inspection of the measurements and perhaps provides insight into why LiDAR measurements, prone to error, do not provide perfect discriminatory power on edge cases. Both measurement and model errors are capable of providing bias to this test statistic. The uncertainty of the measuring process is included in the ray-casting process, however measurement uncertainty still blurs the evidence in support of either the null or alternative hypotheses.

Verification errors will always occur while measurement and model uncertainty exists. These can be traded against each other by changing the level of uncertainty ascribed to the measurement model. For instance, if the Type I errors (spurious trips) are considered excessive, it is possible to configure the system so that these occur less frequently, but at the risk of higher frequency of Type II errors (dangerous failures). The somewhat arbitrary selection of τ makes it possible to achieve an acceptable balance.

The test was repeated using a dipper model that had been scaled by 125% to simulate a change-out of the dipper. In this instance, all of the tests reject the null, in effect, telling us that the dipper is not what and where the automation system understands it to be. Similar results follow for appropriately large changes in pitch-brace length. Overall, the method presented in this section provides a robust approach to verification of dipper form and location. The method is limited by the computational effort required to produce a result. A typical test running on a single 3.40 GHz (Intel i7-2600) CPU takes approximately 410 seconds to complete. Ray-casting accounts for approximately 99.5% of this computation time. A real time strategy requires that the result be delivered faster.

Comparing Multiple Hypotheses

The range measurements can be used to support the null over the alternative and vice versa. This section extends on this to determine the support that each range measurement provides to members of a family of alternate hypotheses uniformly distributed over the accessible crowd-hoist extension space.

Beginning by defining m hypotheses, H, discretised over the workspace and denote the j-th hypothesis by Hⱼ. The evidence from measurement zᵢ in support of Hi can be expressed by

$$P ( {H}_{j} \vert {z}_{i} ) = \frac{f ( {z}_{i} \vert {H}_{j} ) \cdot P ( {H}_{j} )}{f ( {z}_{i} )} . \qquad ( 28 )$$

Here, P(Hⱼ), is the prior probability of the pose, which, in the absence of other information is considered equally as likely as any other, hence a uniform distribution can be used to map this belief, i.e.

$$P ( {H}_{j} ) = \frac{1}{m} . \qquad ( 29 )$$

Recognising that the denominator in Eqn. 28 acts as a normalizing constant,

P(Hⱼ)|zᵢ)∝ƒ(zᵢ|Hⱼ), (30)

That is, the conditional probability of a hypothesis is proportional to the conditional likelihood that it would provide the observed range measurement.

Kernel density estimation, as used to approximate the range pdfs, can be used to approximate the conditional range likelihoods, \hat{ƒ}(zᵢ|Hⱼ) The likelihood of each measurement (i=1, . . . , n) is determined against the m hypotheses (j=1, . . . , m) from a collection of ray-casts (k=1, . . . , N) against the geometry model located at Hⱼ. The simulated measurements are again subject to sensor registration uncertainty w and measurement uncertainty v,

\hat{z}_{i,j,k}=rᵢ(Hⱼ,wₖ)+vₖ, (31)

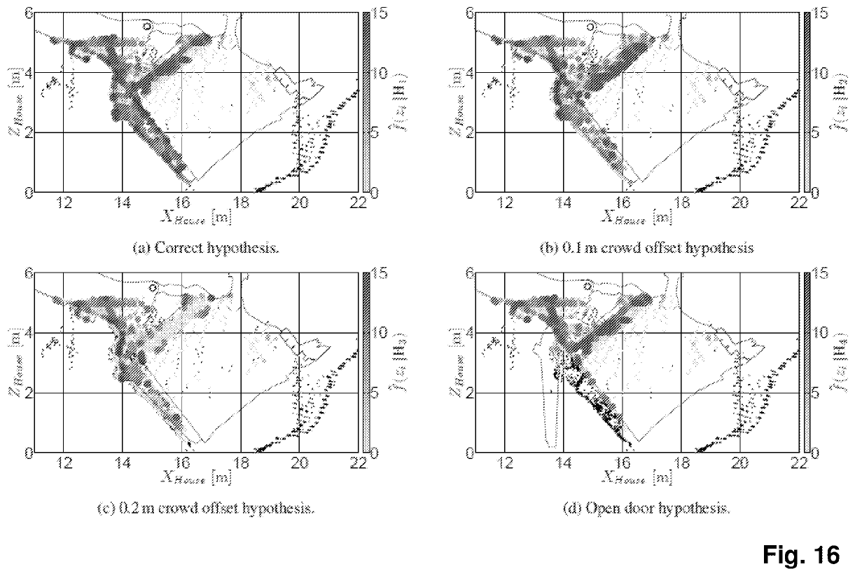

FIG. 16 shows the likelihood of each measurement under four hypotheses where likelihood is indicated by the intensity of the circle associated with each measurement. The first pose hypothesis, H₁, represents the actual location. The dipper is crowded forward 0.1 m for H₂. Under this displacement, measurements on the side of the handle are still equally likely due to the fact that the vertical surface they intersect does not move perpendicular to the ray. Measurements on the dipper door, however, are no longer consistent with the model resulting in a decrease in probability density. Measurements become even less likely when the dipper is crowded forward a further 0.1 m for hypothesis, H₃. The final hypothesis, H₄, is the same crowd-hoist state as H₁, however the dipper-door is open 40 degrees.

LiDAR rays that are likely under a pose hypothesis can be considered as ‘evidence’ in support of that hypothesis (as per Eqn. 30). Summing this ‘evidence’ across all measurements provides a map across the hypothesis space. The hypothesis with the most support is an estimate of the location of the dipper.

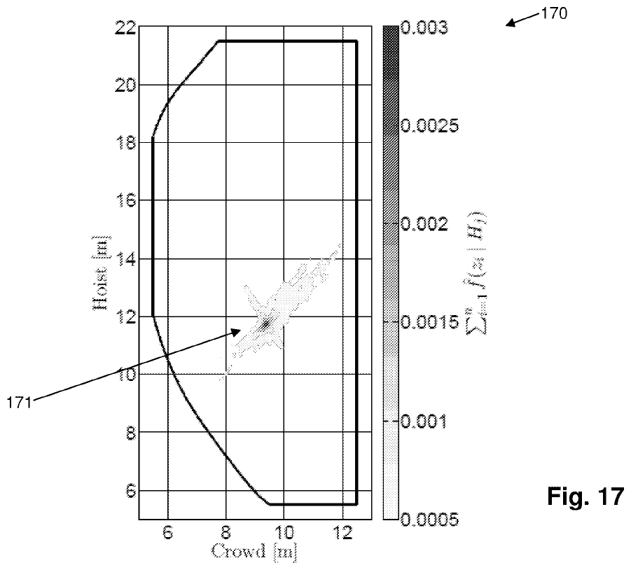

FIG. 17 shows the aggregated measurement likelihood of 10 001 pose hypotheses 170 obtained by discretising the crowd-hoist workspace at 0.1 m resolution. A very sharp peak 171 is located at \hat{x}=[9.4 m, 11.7 m], which represents the closest hypothesis to the true pose x=[9.38 m, 11.71 m].

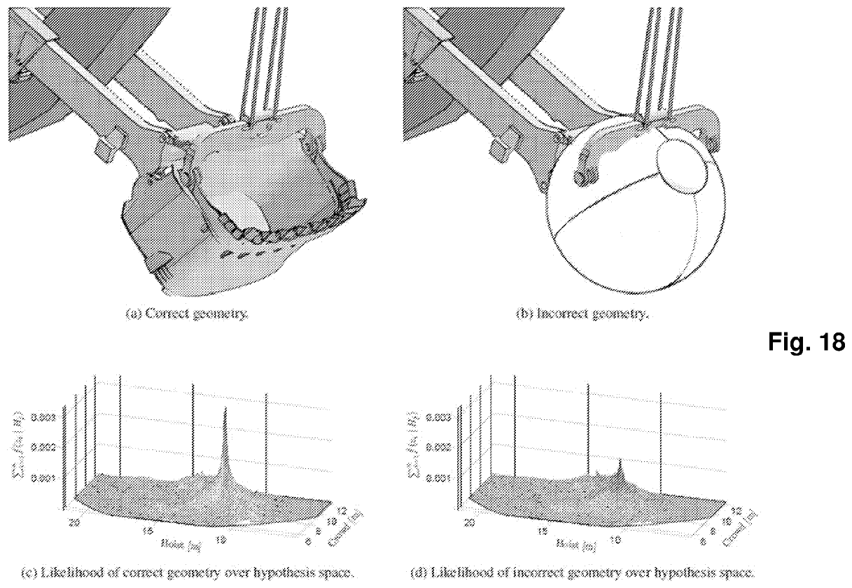

The method is capable of selecting the most likely hypothesis, but offers no protection against an incorrectly assumed geometric form. Consider the situation that would arise if the pose estimated from an incorrect geometry was found to be consistent with the expectation. This situation is illustrated in FIG. 18 where the dipper has been replaced by a beach-ball. In this example, the assumed geometry is palpably wrong, yet the estimated pose is the same as that determined with the true geometry model. The key indicator of incorrect geometry is a diffusion in the likelihood maps (FIGS. 18c and 18d).

A high peak in the distribution suggests that the model is correct in that the measurements coherently agree on the hypothesis that they provide evidence to. A low peak implies that the assumed geometry did not fit the data and is suggestive that the model is incorrect. It has been found that applying a minimum threshold on the height of this peak provides a means for differentiating between a correct and incorrect geometry model.

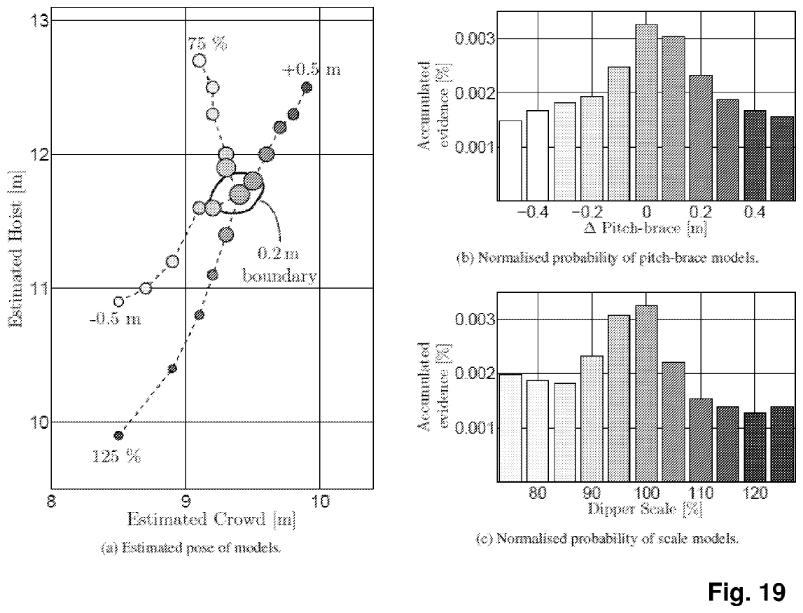

We demonstrate this idea towards the detection of (i) changes made to the pitch-brace length and (ii) different sized dippers. FIG. 19a shows that the pose estimates of these incorrect geometry models disagree significantly with the reported crowd-hoist pose of the dipper. This alone is enough to detect that the object is not ‘where-and-what’ the automation systems believes it to be. The height of the peaks, however, could be used to alert the automation system that the geometry is incorrect in the event that the pose estimate is agreeable to that reported. FIGS. 19b and 19c show that the height of the peaks decrease with model mismatch. An incorrect model could be identified if the peak was found to be below a specified tolerance.

In effect, this approach sequentially answers “where is it?” (an estimation problem) followed by “is it what I think it is, given I believe it to be here?” (a verification problem). This two part approach cannot isolate if the problem lies in the reported pose (‘where’) or the assumed geometry (‘what’), however, it does provide the capability to detect when at least one of these are incorrect, answering the question “Is it where and what I think it is?”.

### CONCLUSIONS

The embodiments provide geometry verification that can be achieved from high-density LiDAR measurements. Two related methods have been presented. The first finds the probability of the null hypothesis for a given measurement set, P(H₀|z). This approach was shown to produce good results, albeit with Type I and Type II errors at the boundary of the region describing the null hypothesis in crowd/hoist-extension space.

A second approach followed that determines the most likely location of an object by summing the level of support provided by each measurement across a family of hypotheses. It is argued that the shape of the resulting distribution reveals if an object is what and where it is believed to be. Specifically, a peaky distribution suggest strong evidence for an hypothesis over others. This second approach has the benefit that it can be implemented on parallel processors, e.g. a GPU, allowing for real-time verification at video rates.

It might be sensible to use the same LiDAR data to determine where the dipper is directly and avoid issues associated with indirect measurement, bias, slack ropes, incorrect geometry models, and so on. Or even do away all together with the need for geometry models and work directly from an occupancy grid constructed from the sensor data. Indeed it might be argued such approaches remove the need for verification all together given that the sensor images the objects of interest directly. Such arguments, however, forget that the problem being solved is not how to determine which parts of space are occupied, but rather to verify that information possessed by an automation system, irrespective of how it was acquired, is correct as part of a process that makes the likelihood of dangerous failures tolerable.

Interpretation

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method of determining the location of a candidate object in an environment, the method including the steps of:
(a) capturing a 3D point cloud scan of the candidate object and its surrounds;
(b) determining a surface geometry model of the candidate object.
(c) forming a range hypothesis test comparing an expected range from the geometry model of the candidate object with the measured range of points in the 3D point cloud scan and deriving an error measure there between; and
(d) testing the range hypothesis for a series of expected locations for the geometry model of the candidate object and determining a likely lowest error measure.

2. The method of claim 1, wherein said method is carried out on a series of different geometry models for different candidate object shapes.

3. The method of claim 1, wherein said step (d) includes accounting for scan sensor pose and measurement uncertainty in the 3D point cloud scan model.

4. The method of claim 1, wherein said 3D point cloud scan comprises a LiDAR scan of the object and its surrounds.

5. The method of claim 1, wherein said candidate object comprises a shovel bucket.

6. The method of claim 1, wherein the testing of a range hypothesis includes determines the most likely location of a candidate object by summing the level of support provided by each measurement across a family of possible range hypotheses.

7. A system for implementing the method of claim 1.
